(19) United States
(12) Patent Application Publication
(10) Pub. No.: US 2006/0232985 A1
(43) Pub. Date: Oct. 19, 2006

(54) Portable searchlight device

(76) Inventor: Lo Pin Wang, Taichung (TW)

Correspondence Address: CHARLES E. BAXLEY, ESQ., 90 JOHN STREET, THIRD FLOOR, NEW YORK, NY, 10038, US

(21) Appl. No.: 11/100,118

(22) Filed: Apr. 5, 2005

(51) Int. Cl. F21S 8/00

(52) U.S. Cl. 362/425

(57) ABSTRACT

A portable searchlight device includes a container, a receptacle rotatably attached onto the container with a shaft, to allow the receptacle to rotate freely relative to the container about the shaft, a lamp holder is disposed in the receptacle and includes a lamp, and a rotating device may be used for rotating the receptacle relative to the container to any selected angular position. The container includes two conductor members and the receptacle also includes two conductor elements electrically connected with the conductor members of the container respectively, for allowing the receptacle to be electrically coupled to the container even when the receptacle is rotated relative to the container.

### BACKGROUND OF THE INVENTION

1. Field of the Invention

The present invention relates to a portable searchlight device, and more particularly to a portable searchlight device having a well sealed structure, and having a structure for allowing the lamp device to be freely rotated to any angular positions.

2. Description of the Prior Art

Typical portable searchlight devices comprise a lamp unit rotatably disposed or supported within a housing, and rotatable in both the vertical direction and the horizontal direction by a vertical driving device and a horizontal driving device respectively, for generating and transmitting light toward various directions, and a remote-control device may be provided for tilting and rotating the lamp unit relative to the housing.

For example, U.S. Pat. No. 5,490,046 to Gohl et al., and U.S. Pat. No. 5,673,989 to Gohl et al. disclose two of the typical portable searchlight devices each also comprising a lamp unit rotatably disposed or supported within a housing, and a remote-control device for tilting and rotating the lamp unit relative to the housing.

For allowing the lamp unit to be tilted or rotated relative to the housing, a gap should be formed and provided between the lamp unit and the housing. However, the gap formed between the lamp unit and the housing should be formed and provided around the lamp unit, and should also be faced forwardly, and the typical portable searchlight devices are normally provided for attaching on top of the vehicles, such that the lamp unit and the housing should be faced toward the wind, and such that the wind and the rain and the dirt and other fluid or particles may have a good chance to enter into the housing via the gap formed between the lamp unit and the housing.

In addition, an electrical control box is required to be provided and coupled to the vertical driving device and the horizontal driving device via electric cables respectively, and the electric cables may limit the rotational movement of the horizontal driving device relative to the base support member for the housing.

The present invention has arisen to mitigate and/or obviate the afore-described disadvantages of the conventional portable searchlight devices.

### SUMMARY OF THE INVENTION

The primary objective of the present invention is to provide a portable searchlight device including a well sealed structure for preventing the portable searchlight device from being wetted and damaged by dirt.

The other objective of the present invention is to provide a portable searchlight device including a structure for allowing the lamp device to be freely rotated to any angular positions.

In accordance with one aspect of the invention, there is provided a portable searchlight device comprising a container, a receptacle rotatably attached onto the container with a shaft, to allow the receptacle to rotate freely relative to the container about the shaft, a lamp holder disposed in the receptacle, and including a lamp for generating and emitting a light out through the receptacle, and a rotating device for rotating the receptacle relative to the container to any selected angular position.

The container includes a first conductor member and a second conductor member disposed thereon, and the receptacle includes a first conductor element and a second conductor element attached thereto, and electrically connected with the first and the second conductor members of the container respectively, for allowing the receptacle to be electrically coupled to the container even when the receptacle is rotated relative to the container. The first and the second conductor members of the container may be peripheral conductor members.

The container includes a peripheral gear provided therein, the rotating device includes a motor attached to the receptacle and having a pinion engaged with the peripheral gear of the container, to rotate the receptacle around the container when the pinion is engaged around the peripheral gear of the container. The container includes a peripheral channel formed therein and defined between two peripheral protrusions, the peripheral gear is formed in either of the peripheral protrusions of the container.

The lamp holder is rotatably attached to the receptacle with an axle to allow the lamp holder to be rotated upwardly and downwardly relative to the receptacle to different vertical and angular positions, and the receptacle includes a driving device for rotating the lamp holder relative to the receptacle to any selected vertical and angular position.

The driving device includes a sector attached to the lamp holder, and a motor having a pinion engaged with the sector, for rotating the lamp holder relative to the receptacle. The receptacle includes two side panels attached to two sides thereof respectively, and each having a tube extended therefrom, for rotatably supporting the axle.

The lamp holder includes a reflector provided therein, and the lamp is engaged in the reflector, for allowing the light to be reflected by the reflector, and then to emit out through the receptacle. The receptacle includes a window made of transparent materials, for allowing the light to emit out through the window of the receptacle.

The container includes a base attached to bottom thereof, and device for releasable attaching the base on a supporting surface. The releasable attaching device includes a boot for engaging with the supporting surface and for selectively forming a vacuum-tight relation to the supporting surface.

The boot includes a guide member secured thereto, and an actuating device for actuating the guide member to move up and down relative to the boot, to selectively secure the boot in a vacuum-tight relation to the supporting surface. The boot includes a stem secured to the guide member, and the actuating device includes a bore formed therein for slidably and rotatably receiving the stem of the boot, and includes at least one inclined actuating surface provided thereon, for engaging with the guide member, and for selectively drawing the boot into the vacuum-tight relation to the supporting surface.

The guide member includes at least one inclined actuating surface provided thereon, for engaging with the inclined actuating surface of the actuating device. The actuating device includes a cavity formed in top of the inclined actuating surface, for receiving and supporting a bottom point of the guide member.

The base includes a casing having a space formed therein and defined by an outer peripheral fence, for engaging with and for positioning an outer peripheral flange of the boot. The releasable attaching device includes at least one magnetic member disposed in the base for selectively securing the base onto the supporting surface.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a portable searchlight device in accordance with the present invention;

FIG. 2 is a front perspective view of the portable searchlight device;

FIG. 3 is a partial cross sectional view of the portable searchlight device, taken along lines 3-3 of FIG. 2;

FIG. 4 is another partial cross sectional view of the portable searchlight device, taken along lines 4-4 of FIG. 2;

FIG. 5 is a partial cross sectional view similar to FIG. 4, illustrating the operation of the portable searchlight device;

FIGS. 6, 7 are enlarged partial cross sectional views illustrating the operation of the portable searchlight device; and

FIG. 8 is a perspective view illustrating the other arrangement of the portable searchlight device.

### DETAILED DESCRIPTION OF THE PREFERRED EMBODIMENT

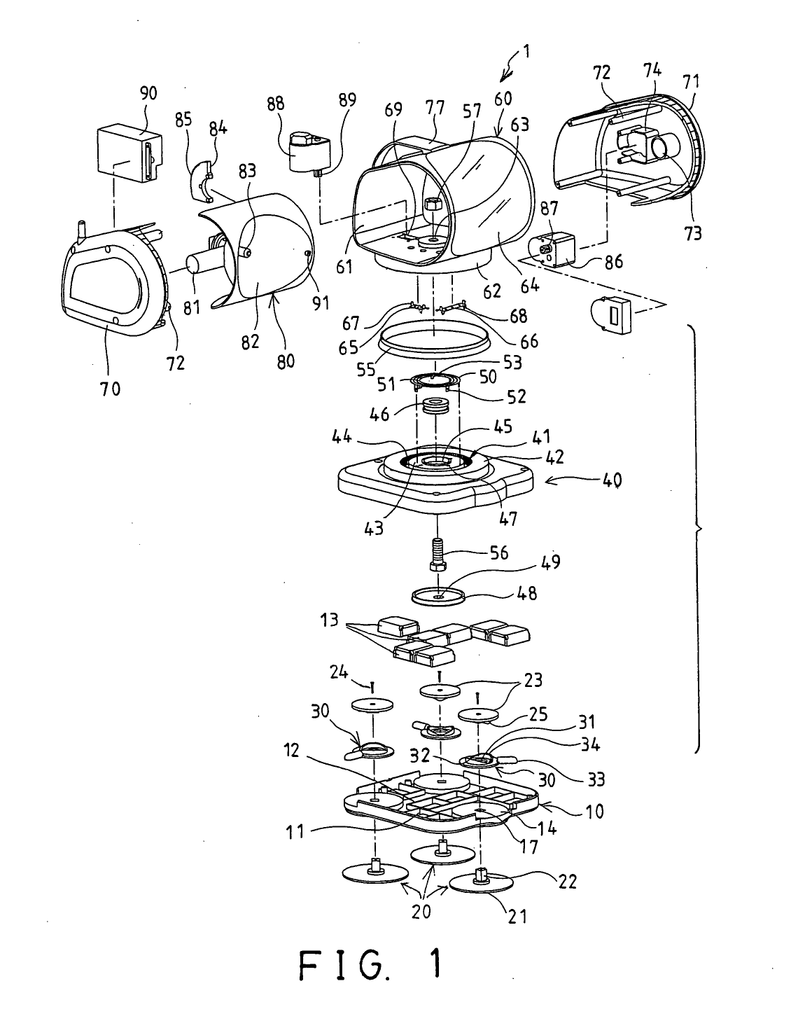

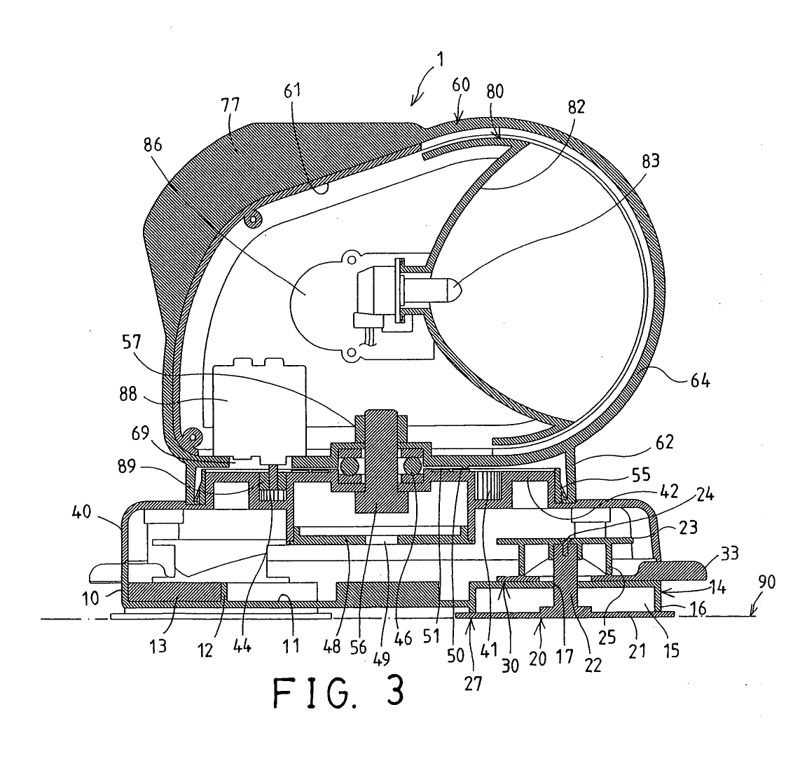

Referring to the drawings, and initially to FIGS. 1-4, a portable searchlight device 1 in accordance with the present invention comprises a base 10 including one or more compartments 1 formed therein and defined by ribs or partitions 12, for receiving releasable attaching members or magnets or magnetic members 13 therein respectively. The releasable attaching members or magnets or magnetic members 13 may be used for magnetically attracting or securing or releasable attaching the base 10 on top of a supporting surface 90 (FIG. 3) of various objects, such as the vehicles (not shown).

The base 10 may further include one or more casings 14 formed or provided therein and each having a space 15 formed therein and defined by an outer peripheral fence 16, for attaching a releasable attaching device 20 thereto. For example, the releasable attaching devices 20 each includes a suction cup or a boot 21 of resilient or flexible or rubber or rubber-like materials, for being drawn into a vacuum-tight relation to the supporting surface 90 of the objects or the vehicles.

Each of the boots 21 includes a stem 22 attached to or extended upwardly from a center portion thereof, and slidably engaged upwardly through a hole 17 of each casing 14 (FIGS. 1 and 3-5). A guide member 23 is secured on top of the stem 22 of each of the boots 21 with one or more fasteners 24, to allow the guide member 23 and the stem 22 of the boots 21 to be moved in concert with each other. Each guide member 23 further includes one or more tapered or inclined walls or guide surfaces 25 extended downwardly or provided in the lower or bottom portion thereof.

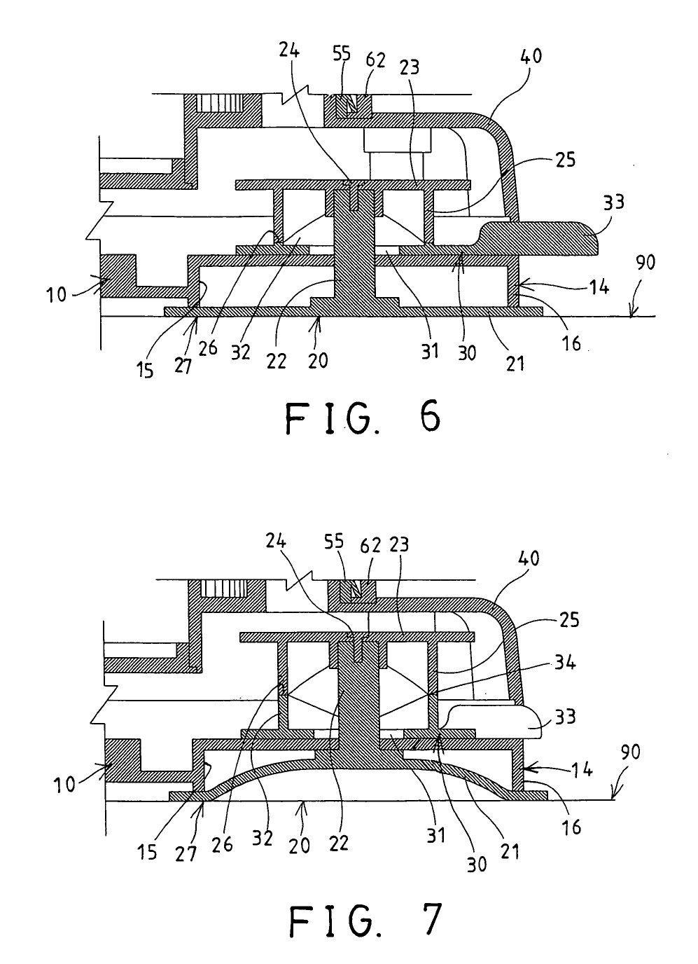

An actuating means or device 30 is further provided and includes a bore 31 formed therein for slidably and rotatably receiving the stem 22 of the respective boots 21, and for allowing the actuating device 30 to be disposed between the boots 21 and the guide members 23. The actuating device 30 further includes one or more tapered or inclined walls or actuating surfaces 32 extended upwardly or provided in the upper portion thereof, for engaging with the corresponding tapered or inclined walls or guide surfaces 25 of the guide members 23, and thus for selectively actuating or drawing the suction cups or the boots 21 into the vacuum-tight relation to the supporting surface 90 of the objects or the vehicles, best shown in FIGS. 6 and 7.

It is preferable that the actuating device 30 includes a hand grip 33 extended therefrom, and extended out of the base 10, for rotating the actuating means or device 30 relative to the base 10, and thus for forcing or moving the guide members 23 either upwardly away from or downwardly toward the supporting surface 90 (FIGS. 6, 7), by the sliding engagements between the tapered or inclined actuating surfaces 32, 25 of the actuating device 30 and of the guide members 23 respectively.

It is further preferable that the actuating device 30 includes a flat surface or a cavity 34 formed or provided on top of each of the tapered or inclined actuating surfaces 32 thereof, for stably receiving or seating or retaining the bottom point 26 of the guide members 23 respectively, and thus for stably supporting and retaining the guide members 23 at the upward position or for maintaining the suction cup or the boot 21 in the vacuum-tight relation to the supporting surface 90, as shown in FIG. 7.

As also shown in FIGS. 3-7, the outer peripheral fence 16 of each of the casings 14 of the base 10 may be engaged onto the outer peripheral portion or the outer peripheral flange 27 of the boot 21 of each of the releasable attaching devices 20, for solidly attaching or positioning or anchoring the outer peripheral flange 27 of the boot 21 to the supporting surface 90, and for allowing the boot 21 to be effectively drawn into the vacuum-tight relation to the supporting surface 90.

A cover or container 40 is further provided and secured onto the top of the base 10, or the base 10 is secured to the bottom portion of the container 40 with such as fasteners, latches (not shown), or by adhesive materials or by welding processes, and the container 40 includes an annular or peripheral channel 41 formed in the upper portion thereof, and defined by one or more, such as two peripheral protrusions 42, 43, and further includes an annular or peripheral gear 44 formed in the peripheral channel 41 thereof. For example, the annular or peripheral gear 44 may be formed on the inner peripheral portion of the outer peripheral protrusion 42 as an internal gear, or may be formed on the outer peripheral portion of the inner peripheral protrusion 43 as an external gear.

The container 40 further includes a recess 45 formed in the center portion thereof or formed in the inner peripheral protrusion 43, for partially receiving a bearing 46 therein, and further includes a number of apertures 47 formed in the upper portion thereof. Two annular or peripheral conductor members 50, 51 are disposed or attached onto the inner peripheral protrusion 43 of the container 40, and spaced away from each other, and each includes one or more terminals 52, 53 extended therefrom, and engaged through the apertures 47 of the container 40, for electrically coupling to electric energy source with such as electric wires or cables (not shown).

A cap 48 may further be provided and attached or secured to a bottom portion of the container 40, for enclosing the container 40, for example. The cap 48 may include a bore 49 formed therein for receiving the electric wires or cables, and for allowing the electric wires or cables to be electrically coupled to the electric energy source. After the electric wires or cables have been engaged through the bore 49 of the cap 48, a sealing glue or the like may be engaged into the bore 49 of the cap 48, in order to enclose and to seal the bore 49 of the cap 48, and to prevent the water or the dirt from entering into the container 40.

A receptacle 60 is rotatably attached or engaged onto the container 40 with the bearing 46, and includes a hollow chamber 61 formed or provided therein, and includes a peripheral skirt 62 dependent downwardly therefrom, for engaging onto the outer peripheral protrusion 42 of the container 40. It is preferable that a gasket or sealing ring 55 is engaged between the outer peripheral protrusion 42 of the container 40 and the peripheral skirt 62 of the receptacle 60, for forming an air tight or a water tight seal therebetween.

A fastener or a shaft 56 may be engaged through the recess 45 of the container 40 and the bearing 46, and may then be engaged through an orifice 63 of the receptacle 60, for threading with a lock nut 57, and for rotatably securing the receptacle 60 onto the container 40, and thus for allowing the receptacle 60 to be rotated freely relative to the container 40 with or about the shaft 56. It is preferable that the receptacle 60 includes a front window 64 made of transparent or semi-transparent materials, for allowing light to emit out through the window 64 of the receptacle 60.

Two conductor bars or elements 65, 66 are further provided and secured to bottom of the receptacle 60, and each includes one or more terminals 67 extended upwardly therefrom, and one or more terminals 68 extended downwardly therefrom, for engaging or coupling to the peripheral conductor members 50, 51 respectively, and thus for electrically coupling to peripheral conductor members 50, 51 respectively, even when the receptacle 60 is rotated relative to the container 40. Alternatively, the conductor elements 65, 66 may be annular or peripheral conductor elements 65, 66 for engaging with the conductor bars or members 50, 51 respectively.

The receptacle 60 includes a passage 69 formed therein, such as formed in the bottom portion thereof and aligned with the peripheral channel 41 of the container 40 (FIGS. 3-5). The receptacle 60 includes two side panels 70, 71 attached onto two sides thereof respectively, and each having one or more studs 72 extended therefrom. The studs 72 of the side panels 70, 71 are preferably aligned with each other for engaging with fasteners (not shown), which may secure the side panels 70, 71 together, and which may thus secure the side panels 70, 71 onto the two sides of the receptacle 60.

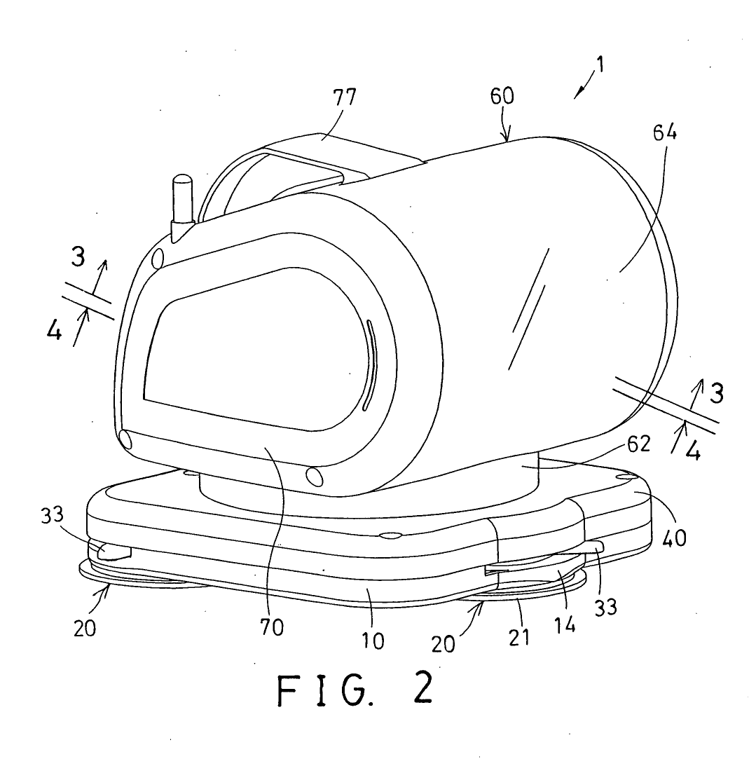

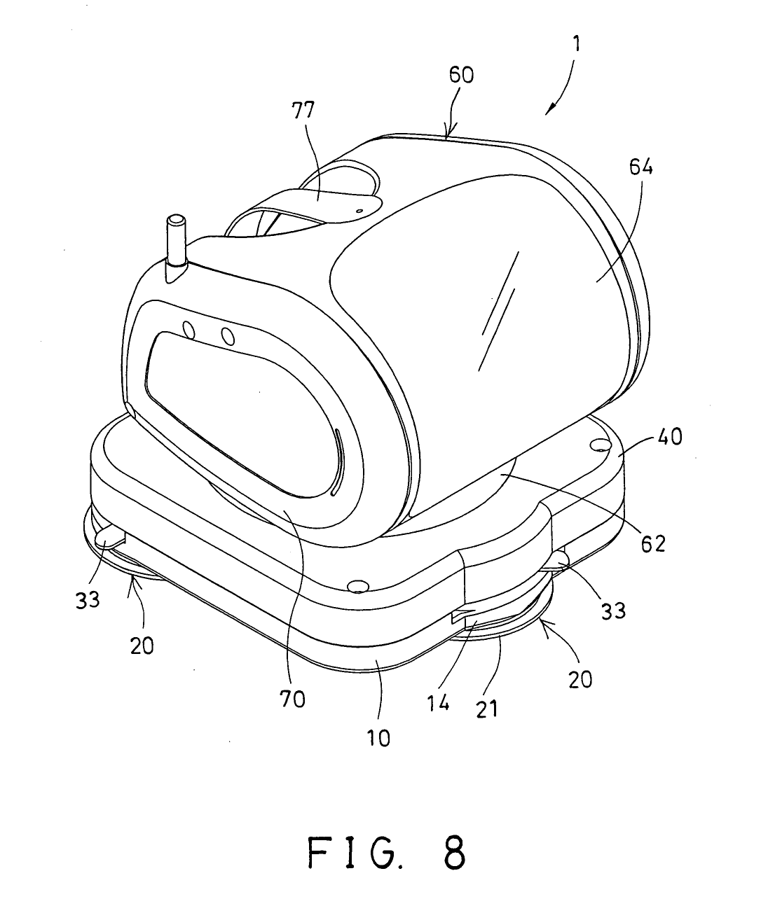

The side panels 70, 71 each may further include a tube 73 extended therefrom, and a box 74 extended therefrom. A lamp holder 80 is disposed in the chamber 61 of the receptacle 60, and includes an axle 81 laterally extended therefrom and rotatably engaged in the tubes 73 of the side panels 70, 71, for allowing the lamp holder 80 to be rotatably attached to the receptacle 60, and arranged for allowing the lamp holder 80 to be rotatably upwardly and downwardly relative to the receptacle 60 to different angular positions. The receptacle 60 may include a handle 77 of various shapes (FIGS. 2 and 8), for carrying purposes.

The lamp holder 80 includes a reflector 82 formed or provided therein, and a lamp 83 engaged in the reflector 82, for generating and emitting light, and for allowing the light to be reflected by the reflector 82, and then for allowing the light to emit out through the window 64 of the receptacle 60. A sector gear 84 is secured to the rear portion of the lamp holder 80, and includes a number of teeth 85 formed or provided thereon.

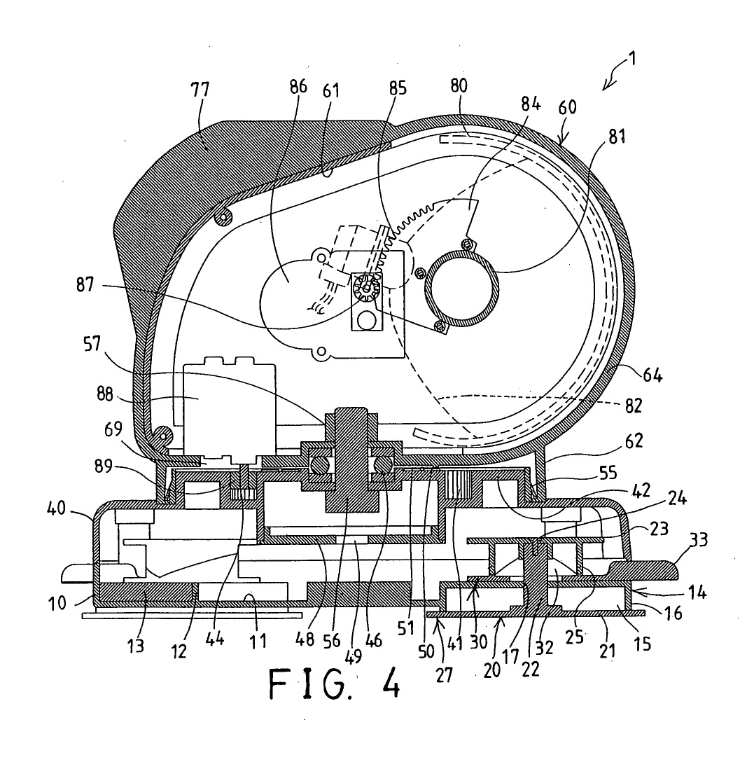

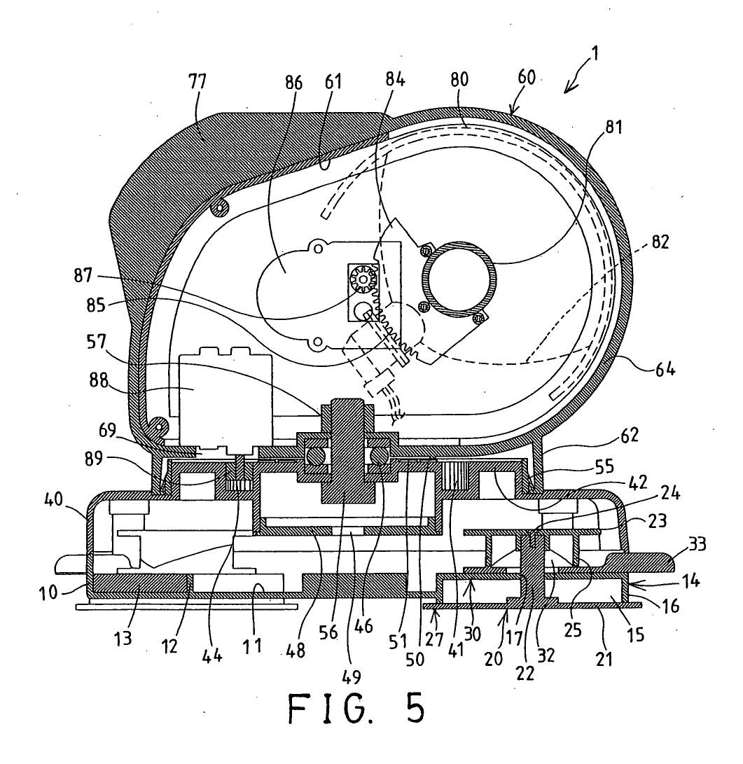

A driving means or device or a motor 86 is attached to the box 74 of the side panel 71, and includes a pinion 87 attached to the spindle thereof, and engaged with the teeth 85 of the sector gear 84 (FIGS. 4, 5), for rotating the lamp holder 80 upwardly and downwardly or vertically relative to the receptacle 60 to different angular positions. Another driving means or device or motor 88 is attached to the receptacle 60, and includes a pinion 89 engaged through the passage 69 of the receptacle 60, and engaged into the peripheral channel 41 and engaged with the peripheral gear 44 of the container 40 (FIGS. 3-5), for rotating the lamp holder 80 horizontally relative to the container 40 to different angular positions.

It is to be noted that the pinion 89 of the driving device 88 is engaged into the annular or peripheral channel 41 of the container 40 and engaged with the peripheral gear 44 of the container 40, such that the pinion 89 may be moved around and around the annular or peripheral channel 41 of the container 40, and such that the lamp holder 80 and the receptacle 60 may be rotated horizontally and freely relative to the container 40 to any different angular positions. The driving device 88 and the peripheral gear 44 of the container 40 may thus be formed as a rotating means or device for rotating the receptacle 60 relative to the container 40 to any selected angular positions.

It is preferable that a control box or device 90 (FIG. 1) may further be provided and attached to the box 74 of the other side panel 70, and electrically coupled to the driving means or devices 86, 88 and/or the lamp 83, for energizing or actuating or operating the driving means or devices 86, 88 and/or the lamp 83. As also shown in FIG. 1, a camera device 91, such as a charge couple device (CCD) 91 may further be provided and attached to the lamp holder 80, for taking photographs or for shooting films, etc.

It is to be noted that the moveable engagement of the pinion 89 of the driving device 88 in the annular or peripheral channel 41 of the container 40 and with the peripheral gear 44 of the container 40 allows the lamp holder 80 and the receptacle 60 to be rotated freely relative to the container 40 to any different angular positions, due to the rotational and sliding engagement between the conductor elements 65, 66 and the peripheral conductor members 50, 51 respectively.

In addition, the lamp holder 80 is rotatably received in the receptacle 60, and rotatable to various vertical angular position relative to the receptacle 60, as shown in FIGS. 4, 5, to allow the lamp holder 80 to be suitably received and sealed and protected within the receptacle 60, or the receptacle 60 may face the wind and may prevent the dirt or the rain or other dirt or particles from blowing into the lamp holder 80 and the receptacle 60, such that the working life of the portable searchlight device may be greatly increased.

Accordingly, the portable searchlight device in accordance with the present invention includes a well sealed structure for preventing the portable searchlight device from being wetted and damaged by dirt, and includes a structure for allowing the lamp device to be freely rotated to any angular positions.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A portable searchlight device comprising:
a container,
a receptacle rotatably attached onto said container with a shaft, to allow said receptacle to rotate freely relative to said container about said shaft,
a lamp holder disposed in said receptacle, and including a lamp for generating and emitting a light out through said receptacle, and
means for rotating said receptacle relative to said container to any selected angular position.

2. The portable searchlight device as claimed in claim 1, wherein said container includes a first conductor member and a second conductor member disposed thereon, and said receptacle includes a first conductor element and a second conductor element attached thereto, and electrically connected with said first and said second conductor members of said container respectively, for allowing said receptacle to be electrically coupled to said container even when said receptacle is rotated relative to said container.

3. The portable searchlight device as claimed in claim 2, wherein said first and said second conductor members of said container are peripheral conductor members.

4. The portable searchlight device as claimed in claim 1, wherein said container includes a peripheral gear provided therein, said rotating means includes a motor attached to said receptacle and having a pinion engaged with said peripheral gear of said container, to rotate said receptacle around said container when the pinion is engaged around said peripheral gear of said container.

5. The portable searchlight device as claimed in claim 4, wherein said container includes a peripheral channel formed therein and defined between two peripheral protrusions, said peripheral gear is formed in either of said peripheral protrusions of said container.

6. The portable searchlight device as claimed in claim 1, wherein said lamp holder is rotatably attached to said receptacle with an axle to allow said lamp holder to be rotated upwardly and downwardly relative to said receptacle to different vertical and angular positions, and said receptacle includes a driving means for rotating said lamp holder relative to said receptacle to any selected vertical and angular position.

7. The portable searchlight device as claimed in claim 6, wherein said driving means includes a sector attached to said lamp holder, and a motor having a pinion engaged with said sector, for rotating said lamp holder relative to said receptacle.

8. The portable searchlight device as claimed in claim 6, wherein said receptacle includes two side panels attached to two sides thereof respectively, and each having a tube extended therefrom, for rotatably supporting said axle.

9. The portable searchlight device as claimed in claim 1, wherein said lamp holder includes a reflector provided therein, and said lamp is engaged in said reflector, for allowing the light to be reflected by said reflector, and then to emit out through said receptacle.

10. The portable searchlight device as claimed in claim 1, wherein said receptacle includes a window made of transparent materials, for allowing the light to emit out through said window of said receptacle.

11. The portable searchlight device as claimed in claim 1, wherein said container includes a base attached to bottom thereof, and means for releasable attaching said base on a supporting surface.

12. The portable searchlight device as claimed in claim 11, wherein said releasable attaching means includes a boot for engaging with said supporting surface and for selectively forming a vacuum-tight relation to said supporting surface.

13. The portable searchlight device as claimed in claim 12, wherein said boot includes a guide member secured thereto, and an actuating means for actuating said guide member to move up and down relative to said boot, to selectively secure said boot in a vacuum-tight relation to said supporting surface.

14. The portable searchlight device as claimed in claim 13, wherein said boot includes a stem secured to said guide member, and said actuating means includes a bore formed therein for slidably and rotatably receiving said stem of said boot, and includes at least one inclined actuating surface provided thereon, for engaging with said guide member, and for selectively drawing said boot into the vacuum-tight relation to said supporting surface.

15. The portable searchlight device as claimed in claim 14, wherein said guide member includes at least one inclined actuating surface provided thereon, for engaging with said at least one inclined actuating surface of said actuating means.

16. The portable searchlight device as claimed in claim 15, wherein said actuating means includes a cavity formed in top of said at least one inclined actuating surface, for receiving and supporting a bottom point of said guide member.

17. The portable searchlight device as claimed in claim 12, wherein said base includes a casing having a space formed therein and defined by an outer peripheral fence, for engaging with and for positioning an outer peripheral flange of said boot.

18. The portable searchlight device as claimed in claim 11, wherein said releasable attaching means includes at least one magnetic member disposed in said base for selectively securing said base onto said supporting surface.
